(19) United States
(12) Patent Application Publication
(10) Pub. No.: US 2015/0018078 A1
(43) Pub. Date: Jan. 15, 2015

(54) System for Importing Non-Gambling Oriented Computer Games to Gambling Venues

(71) Applicants: Caroline Frances Mallary, Reading, MA (US); Jieyu Wu, Malden, MA (US)

(72) Inventors: Caroline Frances Mallary, Reading, MA (US); Jieyu Wu, Malden, MA (US)

(21) Appl. No.: 14/315,543

(22) Filed: Jun. 26, 2014

Related U.S. Application Data
(60) Provisional application No. 61/840,495, filed on Jun. 28, 2013.

(51) Int. Cl. G07F 17/32

(52) U.S. Cl. CPC G07F 17/3288; G07F 17/3227
USPC 463/25

(57) ABSTRACT

A system which interfaces a non-gambling oriented computer game with a gaming machine, with the purpose of allowing the player to wager upon the game or use player-data imported from the game in gambling-oriented games run on the gaming machine. The system implements a scheme to receive wagers and award prizes according to the programming of the interface and/or the gaming machine. The non-gambling oriented computer game may be single-player, multi-player, or a mass-multiplayer online role-playing game, depending on the embodiment. The system may allow players to play the game against the machine, each other, or professional players employed by a gambling venue. The system may incorporate a method of allowing non-participants to wager upon the performance of the player.

### BACKGROUND OF THE INVENTION

For many people, computer games have replaced traditional leisure games. Many people under 40 prefer computer games over table-games such as poker. Computer games are also emerging as a spectator sport, as evidenced by professional gamers who play at conventions such as PAX and the many YouTube videos devoted to video games. Although gambling is restricted by law in many places, legal gambling venues may find that the complex, evolving world of computer gaming can attract customers who are not interested in traditional games of chance. Many non-gambling oriented computer games have a broad fan-base, and some of this fan-base may be interested in playing the game in a gambling context. Gambling is not supported in most popular computer games, because the companies which produce them are not permitted to host gambling venues, and these companies may not wish to devote resources to producing a gambling version of the game which can only be sold to casinos. However, some computer-game companies may be amenable to allowing their popular, non-gambling oriented games to be used by legal gambling venues, even if these companies do not wish to be directly involved in gambling. The system described here, unlike those described in the prior art, enables the importation of these non-gambling oriented computer games to gambling venues.

Mass-multiplayer online role-playing games may offer unique opportunities for gambling, as they often have a very large number of regular players, and generally support player-vs-player challenges. Such games often include character building as part of their gameplay, and regular players will generally have a few Player Characters which they prefer to use to play the game. However, most such games are restricted by the structure of their network, and these Player Characters may only be available when the player is connected to a particular server. In a gambling venue which offered mass-multiplayer online role-playing games, it would be particularly important to enable players to import their preferred Player Characters to a server operated by the gambling venue. In a similar vein, Players may wish to import Player Characters, Avatars, or gaming-based Social-Media Identities to the gambling venue in order to play different games using a familiar digital identity, or may wish to export their achievements within the gambling venue to a Player Character, Avatar, or Social-Media Identity outside the gambling venue. The creation of a mass-multiplayer online role-playing game which is designed for gambling is described in prior art; however, the prior art does not describe a means of modifying a pre-existing game for gambling. It may be desireable to modify a pre-existing game to attract the game's pre-existing fan base.

Finally, computer games may offer similar opportunities for spectator-wagering as traditional sports. In the case of a non-gambling oriented computer game, a spectator-wagering system could be included as part of the interface which allowed gambling.

### PRIOR ART

1. U.S. Pat. No. 8,398,479: System and method for conducting a game of chance, Hardy, et al. Mar. 19, 2013

2. U.S. Pat. No. 8,414,400: Network gaming system, Kelly, et al. Apr. 9, 2013

3. U.S. Pat. No. 8,052,518: Networked gaming system, Kelly, et al. Nov. 8, 2011

4. U.S. Pat. No. 5,618,232: Dual mode gaming device methods and systems, Martin Apr. 8, 1997

5. System and method for incentive programs and award fulfillment, Eggleston et al. Mar. 18, 1998

### DEFINITIONS

Gambling Venue: Any business entity which hosts legal gambling, or any company which owns such entities, or an agent acting on behalf of such entities.

Game Rights Holder: The creators or copyright-holders for a Non-Gambling-Oriented Computer Game, or an agent acting on their behalf.

Non-Gambling-Oriented Computer Game (NGOCG): Any computer game which is not designed by its Game Rights Holder to support gambling. Gambling is here considered to be distinct from Redemption. Games which are modified by their Game Rights Holders to support gambling as part of a business proposition by a Gambling Venue or Facilitator are considered NGOCGs; unless the Game Rights Holder is itself a Facilitator or Gambling Venue. In order to reasonably limit the scope of this patent, computer games whose Game Rights Holders decide to modify said games for gambling without any proposition or specific incentive from Gambling Venues or Facilitators are not considered NGOCGs and are not covered under this patent.

Facilitator: A third party whose business involves facilitating adaptations of NGOCGs for gambling. The facilitator may perform technical, business or legal services. It may be a company whose primary business is creating Gambling-Oriented Computer Games which are sold directly to casinos.

Player or Participant Player: Someone who plays a Gambling-Adapted Computer Game hosted by a Gambling Venue, or who plays a Gambling-Oriented Game using elements imported from NGOCGs.

Gambling-Adapted Computer Game: An NGOCG which has been adapted for gambling using a Gambling Interface Package or a Wrapper Program.

Gambling-Oriented Computer Game: A gambling-oriented game which is not a NGOCG, but which may, under this patent, have the ability to import data such as Player Characters, Avatars, and/or Social-Media Identities from NGOCGs or social media networks.

Gambling Interface Package: A modification to a NGOCG's source-code which adapts it for gambling. The Gambling Interface Package may contain a full suite of gambling-related adaptations, or it may allow the game to communicate with an external program which manages gambling-related activity. When the NGOCG's source-code is compiled with the Gambling Interface Package modification, and the resulting game-program is connected to any necessary external programs, the product is called a Gambling-Adapted Computer Game. A Gambling Interface Package is used in Embodiment 1 (claim 2).

Wrapper Program: A program or software system which can read the outcomes of an NGOCG without any modifications to the NGOCG's source-code. The Wrapper Program is an alternative to a Gambling Interface Package. Unlike a Gambling Interface Package, a Wrapper Program does not become part of the source-code of a Gambling Adapted Game. The Wrapper Program provides a means of adapting NGOCGs for gambling even when the Game Rights Holder prefers not to share or modify the NGOCG's source-code. A Wrapper Program is used in Embodiment 2 (claim 3).

The Wrapper Program may read NGOCG game-outcomes from anywhere where the game-outcomes are accessible. For example, when the game-outcomes are stored in the memory of the machine running the NGOCG, the Wrapper Program may have the ability to access and decode said memory. Alternately, the Wrapper Program may read game-outcomes from the same screen used by the Player. An NGOCG which runs with such a Wrapper Program is considered a Gambling-Adapted Computer Game.

Gambling-Adapted MMORPG (GAMMORPG): An MMORPG (Mass-Multiplayer Online Role-Playing Game), which is a NGOCG, which has been adapted for gambling and can now be considered a Gambling-Adapted Computer.Game.

GAMMORPG Server: A server for a GAMMORPG. Most MMORPGs use servers to allow many Players in different locations to play the same game. A GAMMORPG Server is operated by a Gambling Venue or its agent or Facilitator, and may have the ability to import Player Characters from MMORPG servers which are not operated by the Gambling Venue or its agent or Facilitator.

External Server or External MMORPG Server: A server for non-gambling oriented media which is external to the Gambling Venue, its agents, or Facilitators. An External MMORPG Server specifically runs an MMORPG and is usually operated by the Game Rights Holder of the MMORPG. For example, a World of Warcraft server operated by Blizzard (World of Warcraft's Game Rights Holder) is an MMORPG server which is external to any gambling venues.

Player Character: An entity in a computer game which a Player controls and uses to play the game. Many MMORPGs rely extensively on Character Building. Players of an MMORPG may wish to import their Player Characters to a GAMMORPG Server hosted by a Gambling Venue, its agent, or Facilitator. A Player Character's associated Gear may be considered part of the Player Character.

Character Building: In role-playing games, Character Building a game-long process of allowing the Player to choose new abilities, traits, and Gear for his/her Player Character. Said abilities, traits, and Gear alter the Player's gameplay-experience and chances of success at various in-game challenges.

Avatar: An avatar is a visual representation of someone in digital media. In the context of this patent, an Avatar represents a Player, and the Avatar is specifically an Avatar imported from outside the Gambling Venue. Unlike a Player Character, an Avatar is usually only a visual representation of the Player, and may not have Gear or specific gameplay qualities.

Social-Media Identity: A social-media identity is a representation of someone on digital media, but unlike an avatar, it may be only a name. Some garners enjoy showcasing their in-game achievements on game networks via their social-media identities.

Gear: In-game items such as armor which may modify the traits, abilities, or appearance of a Player Character.

Duel: A Player-vs-Player (PvP) challenge whereby a Player, especially an MMORPG Player, uses his/her Player Character to attempt to “kill” other Player Characters.

Gambling-Oriented Dueling System: A software component which may be included in the Gambling Interface Package or Wrapper Program of a Gambling-Adapted Computer Game, in particular a fighting game, MMORPG, or other PvP-oriented game. The Gambling-Oriented Dueling System enables gambling upon Duels.

PvP, PvE, PvPro: PvP and PvE are common game acronyms referring to different types of challenges. PvP challenges are Player-vs-Player; PvE challenges are Player-vs-Environment. Most computer-game challenges that are not PvP can be considered PvE. PvPro is defined here as Player-vs-Professional, where the professional in question is a Player in the employ of the Gambling Venue, Facilitator, or an agent thereof.

Spectator: A non-participant in any Gambling-Adapted Computer Game who places a wager on the outcome of Participant Players. A Gambling Venue may wish to host games featuring high-profile professional players of a NGOCG which has been adapted into a Gambling-Adapted Computer Game. In such case, the Gambling Venue may profit from the wagering of Spectators rather than the professional Participant Players. This patent covers only the integration of Spectator-wagering into Gambling-Adapted Computer Games; it does not make any claims on the right of Gambling Venues to host or employ professional Participant Players.

Wager: In addition to the standard meaning, a wager may also refer to a deduction from an In-Venue Game Account, whether such a deduction is made on a per-challenge, per-hour, or other basis.

Redemption Games: Redemption-games are games which reward players with non-cash, non-cashable prizes. These prizes either have intrinsic value or must be redeemed for valuable items within the venue. A pinball machine which issues redeemable tickets is an example of a redemption game. Redemption-games are common in arcades and are generally considered to be distinct from gambling-games, as exemplified by the fact that minors are not generally prohibited from playing them. Redemption Games are defined here to distinguish them from Gambling-Oriented Computer Games and Gambling-Adapted Computer Games, and are not claimed under this patent.

In-Venue Game Account: A pool of credit from which a Player may make wagers, from which the Gambling Venue may make deductions for gameplay time, services, or in-game purchases. For example, some Gambling Venues may choose to charge Players per hour of gameplay, rather than requiring them to make wagers on specific in-game challenges. Additionally, a Gambling Venue may award credits to an In-Venue Game Account, which would be considered distinct from Redemption if the credits could be cashed, used to play cash-awarding games, or otherwise considered a gambling-award under applicable law. The details of the payment scheme between Player and Gambling Venue are not relevant to this patent, which is concerned with importing NGOCGs and NGOCG-data to Gambling Venues, and variations on the payment scheme do not depart from the spirit of this patent.

### DETAILED DESCRIPTION OF THE INVENTION

The aim of embodiments of the invention is to allow gambling venues to offer computer games or game-elements which do not normally support gambling.

The preferred embodiment of the invention shall be referred to as Embodiment 1, representing claims 1 & 2. It is illustrated in FIG. 1. Embodiment 1 requires the Game Rights Holder to share the NGOCG's source-code with the Gambling Venue, its agents, or a Facilitator or a Facilitator's agents. When access to the source-code is obtained, it becomes possible to modify the code to allow gambling-based play. This modification is referred to as a Gambling Interface Package. The Gambling Interface Package may be produced by anyone whom the Game Rights Holder authorizes to modify the code. The Gambling Interface Package may be produced by the Game Rights Holder itself if the Game Rights Holder is acting as an agent of the Gambling Venue or a Facilitator. However, in order to reasonably limit the scope of this patent, instances where the Game Rights Holder makes an independent decision to produce and market a Gambling-Adapted version of its game are not claimed under this patent.

After the source-code is modified by inclusion of the Gambling Interface Package, it is then re-compiled to produce a Gambling-Adapted version of the game. The Gambling Venue can offer this Gambling-Adapted Computer Game for play, and the Game Rights Holder may collect fees, royalties, or other compensation from Gambling Venue. The Game Rights Holder may find this embodiment preferable to producing a Gambling-Oriented Game independently, as there may be fewer financial risks and less legal complications when a legal Gambling Venue assumes responsibility for producing and hosting the Gambling-Adapted Computer Game.

In another embodiment, referred to as Embodiment 2, representing claims 1 & 3, the source-code of the game is left unmodified, and gambling-related activity is handled by the Wrapper Program. (FIG. 2.) The Wrapper Program, as defined above, is any program or software system external to the game program which can detect game outcomes, accept wagers, and award prizes. As with Embodiment 1,the Gambling Venue may have to obtain permission and grant compensation to the Game Rights Holder, but the Game Rights Holder need not permit the game's source-code to be modified in any way. A Wrapper program may function similarly to the game management system described in Prior Art 1; however, the Wrapper Program must include code specifically to adapt a Non-Gambling Oriented Computer Game for gambling purposes.

In another embodiment of the invention, representing claim 4, both source-code modifications and a wrapper-program are used. For example, the source-code may contain a minor modification that publishes game-outcomes which are relevant to gambling, in order to make it easier for a Wrapper Program to read these outcomes.

Embodiments of the invention may have the ability to import data created by non-gambling oriented versions of the game. In particular, the embodiment may have the ability to import a Player Character created by the player from an External Server that does not support gambling. This is illustrated in Embodiment 3, representing claims 5, 6, & 7 (FIG. 3). Embodiment 3 is best suited for use with games that are MMORPGs that store Player Characters on their servers. In such an embodiment, the Gambling Adapted Computer Game is given the ability to contact the External MMORPG Server for the purpose of retrieving Player Characters associated with Players in the Gambling Venue. The retrieved Player Characters are used by the Players to play a Gambling-Adapted version of the game (a GAMMORPG) on a server operated by the Gambling Venue, its agent, or a Facilitator or a Facilitator's agent.

A component of some Gambling-Adapted Computer Games is a Gambling-Oriented Dueling System. GAMMORPGs and Gambling-Adapted fighting games in particular are well suited for Dueling. Dueling is a type of player-vs-player challenge which exists within many MMORPGs, and it is a primary component of fighting games. A Gambling-Adapted Computer Game may include code specifically to allow wagering upon Duels. An embodiment of a Gambling-Oriented Dueling System is illustrated in FIG. 4 and detailed in FIG. 4′s description. In the case where the Gambling-Adapted Computer Game is a GAMMORPG which stores its Player Characters on servers, and the Duel makes use of Player Characters which exist on an External MMORPG Server(s), the Player Characters must first be retrieved from the External MMORPG Server(s). During or after the Duel, the Gambling-Oriented Dueling System may award a prize to the winner of the duel, or it may partially reward both players. For example, if Player. 1's Player Character was significantly weaker than Player 2's Player Character, as assessed by the Gambling-Oriented Dueling System, the Gambling-Oriented Dueling System may partially reward Player 1 even if he or she lost the Duel. A Gambling-Oriented Dueling System is described in claim 14.

Another embodiment of the system, referred to as Embodiment 4, representing claims 1, 8 & 9, incorporates code in the Gambling Interface Package or Wrapper Program which allows Spectators to wager upon the performance of Participant Player(s) in the Gambling-Adapted Computer Game. The Gambling-Adapted Computer Game may assesses the odds of the Participant Players' success at various in-game challenges, and may assess the performance of the Participant Player(s) more precisely than an external wagering system. Certain NGOCGs have a broad fan-base which enjoys watching highly skilled players, and therefore Gambling Venues may profit from inviting highly-skilled players to play for Spectators, and using the system described in this patent to allow Spectators to wager upon the performance of these highly-skilled players. Additionally, Spectators may wish to wager upon the performance of common Participant Players, where allowed by law. This patent covers only the integration of Spectator-wagering into Gambling-Adapted Computer Games; it does not make any claims on the right of Gambling Venues to host or employ professional Participant Players, nor does it make any claims upon traditional Spectator-wagering systems which are not incorporated into a Gambling-Adapted Computer Games.

In another embodiment of the invention, only certain elements of a NGOCG are adapted for use as a Gambling-Adapted Computer Game. For example, many modern games contain “mini-games” which can be adapted for gambling independent of the main game.

In another embodiment of the invention, a Player Character, Avatar, or Social-Media Identity is imported from the NGOCG or associated gaming network for use in a Gambling-Adapted version of the game (claim 11). This is useful because some Gambling-Adapted Computer Games may be more appealing to Players if the Player can import a familiar digital identity to the game. This patent builds upon Prior Art 2 & 3 in that it makes use of digital identities associated with the Non-Gambling Oriented version of the Gambling-Adapted Computer Game.

In another embodiment, a Player has the ability to export the outcomes of a Gambling-Adapted Computer Game to an external Player Character, Avatar, or Social-Media Identity associated with a Non-Gambling Oriented games (claims 10 & 12). Some Players enjoy showcasing their achievements online, and major gaming companies have made extensive use of such showcasing as a player perk and promotional tool. This patent covers only the ability to export Gambling-Adapted Computer Game outcomes to external Player Characters, Avatars, or Social-Media Identities associated with Non-Gambling Oriented games. It does not cover the use of user profiles in Gambling-Oriented Games which are not Gambling-Adapted Games, as such use is covered under the prior art, nor does it cover the use of Avatars or Social Media Identities which are not associated with Gambling-Adapted Games or said games' associated gaming networks.

In another embodiment of the invention, referred to as Embodiment 5 (FIG. 6, claims 10 through 13), the Player has the option to both import a Player Character, Avatar, or Social-Media Identity from NGOCGs or networks associated with the NGOCGs, and to export game-outcomes to this Player Character, Avatar, or Social-Media Identity to said NGOCGs and associated networks. In FIG. 6, this non-gambling oriented media is hosted on an external server.

### DESCRIPTION OF FIGURES

FIG. 1. A diagram of Embodiment 1, claim 2. The Gambling Venue or Facilitator obtains permissions and source-code from the Game Rights Holder, and adapts a Non-Gambling Oriented game for gambling by inserting a Gambling Interface Package into the source code and recompiling the game. The Player can then play the game as a Gambling-Adapted Game.

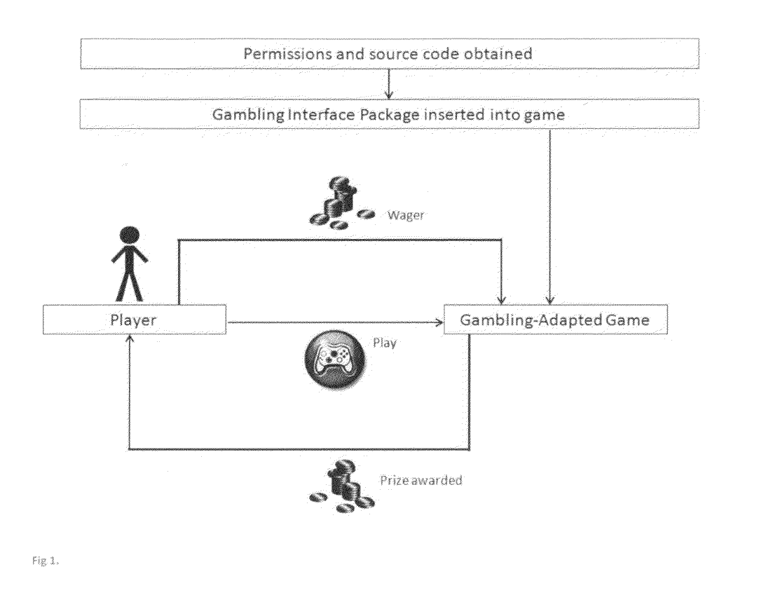

FIG. 2. A diagram of Embodiment 2, claim 3. In this case, the Gambling Venue or Facilitator does not need to obtain the source-code of the Non-Gambling Oriented Game from the Game Rights Holder, though it may still need appropriate permissions. The Gambling Venue runs the game along with a Wrapper Program that allows the Player to wager upon the game. When the Player makes a wager (Step 1), the wager is received by the Wrapper Program. When the Player plays the game (Step 2), game outcomes are registered by the game (Step 3) in a Record of Game Outcomes, in a manner determined by the game's standard compiled code. The Wrapper Program reads the Record of Game Outcomes (Step 4), and may award the Player a prize (Step 5).

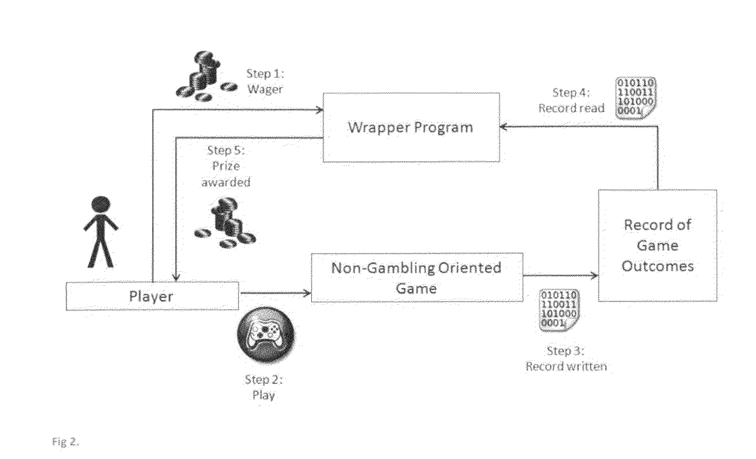

FIG. 3. A diagram of Embodiment 3, claim 7. Here, the Gambling-Adapted Game is an MMORPG, and the Gambling Venue or Facilitator is operating a private Gambling-Adapted MMORPG Server for the game, with permission and cooperation of the Game Rights Holder. When the Player signs on to this server (Step 1), the Player may import a pre-existing Player Character from a Non-Gambling Oriented MMORPG Server operated by the Game Rights Holder or its agent. The Player can then play the MMORPG as a Gambling-Adapted Game, using a preferred Player Character (Step 3), and the Gambling-Adapted MMORPG Server can award prizes (Step 4).

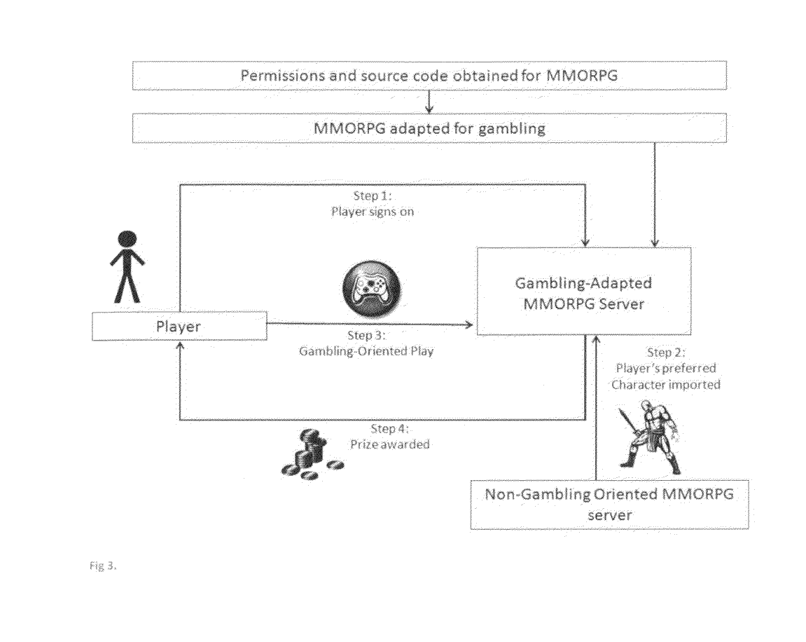

FIG. 4. An embodiment of a gambling-oriented Dueling system, to be coded within a Gambling Interface Package or Wrapper Program for a NGOCG which supports Dueling. Dueling is a type of Player-vs-Player challenge which is supported by many MMORPGs, and is a primary component of fighting games. In the case where the Gambling-Adapted Computer Game is a GAMMORPG which stores its Player Characters on severs, the Player Characters must be retrieved from an external Non-Gambling Oriented MMORPG Server (FIG. 3) prior to any dueling. In the diagram, two Players are playing a Gambling-Adapted Computer Game. In this diagram, one Player is a professional in the employ of the Gambling Venue (the House Player), while the other Player is a visitor to the Gambling Venue. The Visiting Player challenges the House Player to a Duel (Step 1), and wagers are made (Step 2). The Players duel in the game (Step 3). The Gambling-Adapted Computer Game assesses the outcome of the Duel and awards prizes accordingly (Step 4).

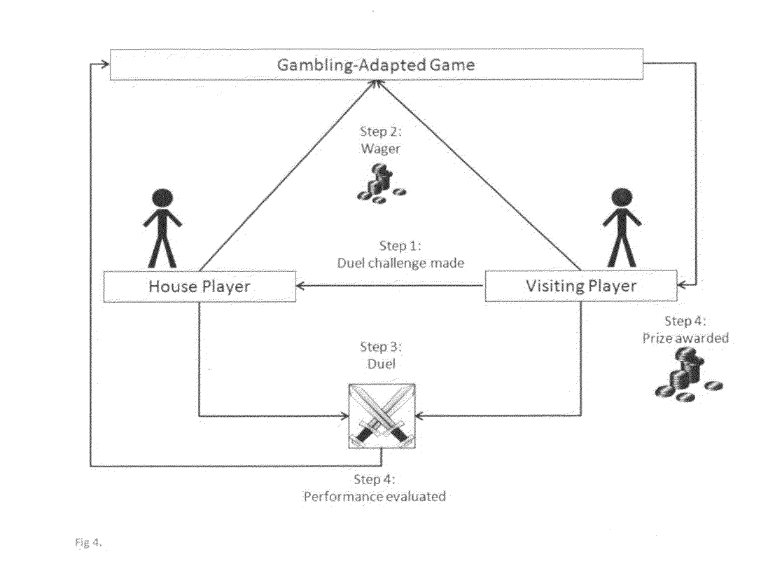

FIG. 5. An embodiment of claims 8 & 9. As in sports gambling, Spectators place bets upon published odds. In this case, the Gambling-Adapted Computer Game assesses the odds and the performance of the Participant Players. Unlike traditional sports gambling, a Gambling-Adapted Computer Game is in a position to gauge performance very precisely, and may have built-in performance metrics such as stylishness which is highly subjective in traditional sports. Furthermore, even amateur Participant Players may have digital player profiles which the Gambling-Adapted Computer Game can use to precisely calculate odds, enabling amateur players to wager upon fellow amateur players where allowed by law. In the case where the Gambling-Adapted Computer Game is a GAMMORPG which stores its Player Characters on severs, the Participant Players' Player Characters must be retrieved from an external MMORPG Server (FIG. 3) prior to any gameplay.

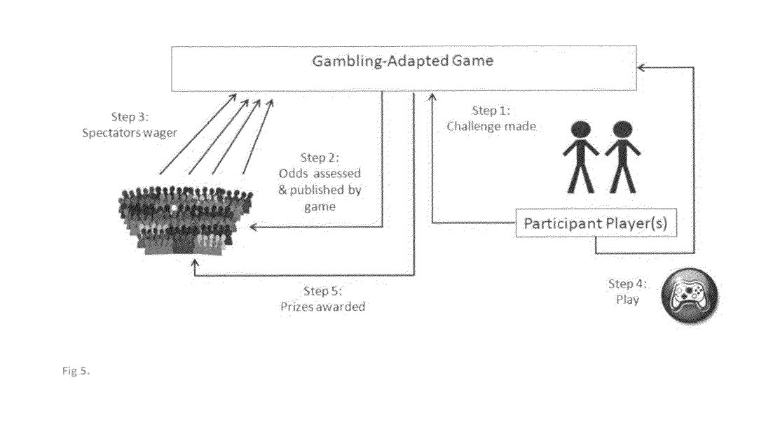

FIG. 6. An embodiment of claims 10 through 13. The Player is importing user data from Non-Gambling Oriented Media in order to play a Gambling-Adapted Computer Game, then exporting results of the Gambling-Adapted Computer Game to said External Server.

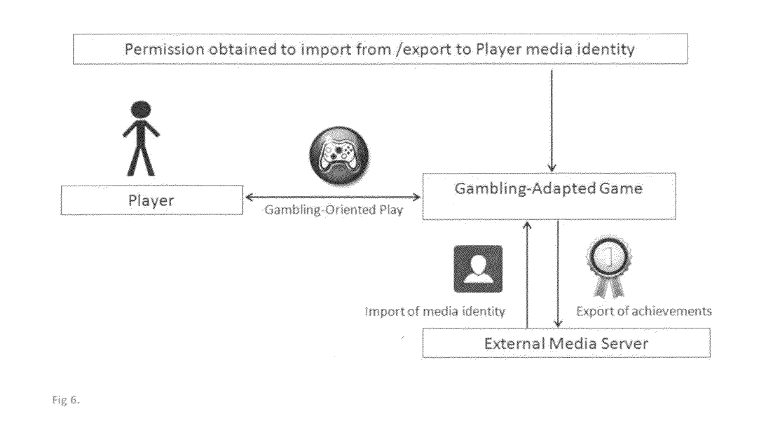

1. A system allowing gambling venues to offer non-gambling oriented computer games for gambling-oriented play, comprising:
a computer game or games which is not originally designed by its creator(s) to support gambling, hereafter referred to as a non-gambling oriented computer game;
computer code which enables said non-gambling oriented computer game or game elements created within it to function as part of a gambling game, said code not being an original part of the game, where said code may be created separately from the creation of the game, or said code may be included in the game on behalf of a gambling venue, its agent, or a facilitator or facilitator's agent, or said code may be packaged with the game on behalf of a gambling venue, its agent, or a facilitator or facilitator's agent, with the intention of attracting players of said non-gambling oriented game to a gambling venue, regardless of whether said game-package is marketed under the same name as the non-gambling oriented version of said game.

2. The system of claim 1, wherein the computer code which enables gambling is inserted into the source-code of the non-gambling oriented computer game, except in the case where the owner of the source-code makes an independent decision to produce a gambling-oriented version of the game, without incentive, proposition, or agreement with a gambling venue, its agent, or a facilitator or facilitator's agent.

3. The system of claim 1, wherein the computer code which enables gambling comprises:
a program or software system external to the source-code of the game, which detects game outcomes via a computer-readable medium, hereafter referred to as a wrapper program.

4. The system of claim 1, wherein said computer code comprises both source-code modifications and a wrapper program.

5. The system of claim 1, wherein said computer code enables players to import data created by a non-gambling oriented version of said game from outside the gambling venue.

6. The system of claim 5, wherein the non-gambling oriented computer game is a mass-multiplayer online role-playing game, additionally comprising:
a mechanism for importing pre-existing player-characters to the gambling venue for the purpose of gambling-oriented play.

7. The system of claim 6, wherein said mechanism for importing player-characters comprises:
an external game-server on which a player has built a player-character;
a gambling-oriented game-server operated by the gambling venue, its agent, or a facilitator or facilitator's agent for the purpose of gambling-oriented play;
an electronic system for copying or transferring the player's player-character from the external game-server to the gambling-oriented game-server.

8. The system of claim 1, additionally comprising:
computer code allowing said game to be wagered upon by spectators.

9. The system of claim 6, additionally comprising:
computer code allowing said game to be wagered upon by spectators.

10. A system for allowing player-characters, avatars, or social-media identities from non-gambling oriented computer games or associated gaming networks to interact with a gambling venue for the purpose of playing gambling-adapted versions of said games, comprising:
a player-character, avatar, or social-media identity which has been created on a machine outside the gambling venue for the purpose of playing non-gambling oriented computer games or representing the player in non-gambling oriented media associated with non-gambling oriented computer games;
a computer game which can interact with said player-character, avatar, or social-media identity, which was originally designed as a non-gambling oriented computer game, which has been adapted by the system of claim 1 and can now be considered a gambling-adapted game;
an electronic system for importing and/or exporting the player's player-character, avatar, or social-media identity between the gambling venue and non-gambling oriented media or non-gambling oriented computer game.

11. The system of claim 10, wherein said gambling-adapted game allows a player to import a player-character, avatar; or social-media identity from a non-gambling oriented computer game or associated non-gambling oriented gaming network for the purpose of completing wager-based challenges in the gambling-adapted game.

12. The system of claim 10, wherein said gambling-adapted game records game outcomes to allow said outcomes to be exported to a player-character, avatar, or social-media identity associated with the non-gambling oriented version of said game.

13. The system of claims 11 & 12, where both the import of player-characters, avatars, or social-media identities and export of game results is possible.

14. The system of claim 1, additionally comprising:
computer code designed to facilitate participant-player gambling upon player-vs-player or player-vs-professional challenges in a gambling-adapted game.
